(19) United States
(12) Patent Application Publication
(10) Pub. No.: US 2002/0177114 A1
(43) Pub. Date: Nov. 28, 2002

(54) Incentive-based learning system to promote products or services

(76) Inventor: James Robertson Klauder, Davis, CA (US)

Correspondence Address: James Robertson Klauder, 3007 Genaro Place, Davis, CA, 95616, US

(21) Appl. No.: 09/862,197

(22) Filed: May 22, 2001

(51) Int. Cl. G09B 7/00

(52) U.S. Cl. 434/323

(57) ABSTRACT

Computer assisted instructional schemes have only begun to exploit the potential of client-server systems and networking technologies. Client systems, running under sophisticated operating systems, can support advanced object based software applications, including high speed graphics, animation and audio output. At the other end, servers can store gigabytes of data and programs at central or distributed locations at quite reasonable cost. Object oriented database systems have been developed to store structured data on servers. The Internet has emerged as a means of providing an inexpensive means of connecting computers to provide effective communications and access to information and other resources such as software.

This invention takes advantage of the technological advances described above. This invention relates to a system and method for interactive and individualized instruction of students in which benefits are awarded in a “real time” process as the student demonstrates proficiency in understanding the subject matter. Preferably this system and method will be implemented by electronic communication via the Internet. However, it can be implemented through other forms of communication. More specifically, the system and method incorporates a process whereby 1) the reward issuing organization can randomly change which responses will generate rewards and 2) the reward issuing organization can collect data on the student as a part of the interactive client-server communication process.

### CROSS-REFERENCE TO RELATED APPLICATIONS

Not Applicable.

### STATEMENT REGARDING FEDERALLY SPONSORED RESEARCH OR DEVELOPMENT

No federally sponsored research or development has contributed to this invention.

### REFERENCE TO A MICROFICHE APPENDIX

Not Applicable.

### BACKGROUND OF THE INVENTION

Organizations (and their agents) are continually engaged in the competitive process of attracting attention to their goods or services. Commercial advertising is one manifestation of that process. Sponsorship of information—often in the form of educational materials—relating to the general area in which the organization's goods or services are used is another manifestation of that process. There are many other ways in which organizations seek to attract the interest of potential customers or members.

Technological advances in the past ten years have opened new channels for the distribution of educational materials to a wide audience, and client-server communications now permit a vast flow of data between those connected via the Internet.

This invention brings together an organization's sponsorship of educational materials, materials often (but not necessarily) relating to the general area in which the organization's goods or services are used, and rewards students/users as they demonstrate their proficiency in mastering an understanding of those educational materials. The rewards, consisting of goods or services provided by the sponsoring organization, are given immediately to participants as they demonstrate a proficiency in understanding the educational materials. The testing of participants and awarding of goods or services takes place virtually instantaneously if this invention is embodied in a system that utilizes the Internet as a means of communication. However, this invention is equally applicable in other forms of communication. Those forms range all the way from conventional mail or phone communication to sophisticated (and yet to be developed) technology-based electronic communication.

### BRIEF SUMMARY OF THE INVENTION

This invention relates to a system and methodology of instruction that incorporates rewards as incentives for learning. This invention includes a basic scheme in which two goals are accomplished: 1) each student/user gains knowledge at his or her own pace, and 2) testing instruments imbedded in the scheme measure the students'/users' understanding of the subject matter and provide immediate rewards for various levels of proficiency. The subject matter and level of intellectual difficulty of the instruction are unlimited within this scheme. One unique element of this system and process is the method whereby benefits are awarded to the participants. The inclusion of testing instruments as a part of the educational materials allows participants to answer questions and find out immediately if the answers are correct and benefit by receiving immediate rewards from the sponsoring organization. Preferably, the “real-time” link between the student/user and the provider of the benefit is best accomplished through Internet-based interactive, client-server technology, although any form of communication can be employed. Another unique element of this scheme is the desirability (although not the necessity) of the sponsoring organization, through the use of available commercial software, to randomly change which of the correct answers or events will result in the awarding of a good or service. By changing the correlation of correct responses to awards, participants are not able to benefit from the experience of other users who have previously taken part in the instruction, made responses, and received awards. By utilizing this testing/award scheme, the sponsoring organization is also able to collect valuable information about the participant.

The advantages of this invention over existing schemes of 1) education, 2) advertising, 3) product and services promotion, and 4) collection of customer information is that this invention serves as a catalyst—by employing incentives—to attract potential customers, clients or members to voluntarily participate in all four areas simultaneously in a very efficient, time-sensitive, and low cost manner. The advantages to the sponsoring organization of utilizing this invention are that it can simultaneously accomplish education, advertising, product and services promotion, and collection of customer information in a very efficient, seamless process.

### BRIEF DESCRIPTION OF DRAWINGS

This patent application has no drawing.

### DETAILED DESCRIPTION OF THE INVENTION

In the following, the system and method of this invention are described, with examples drawn primarily from the way in which commercial firms might utilize it to foster learning in a particular subject area at an elementary level. However, this invention is not so limited. It will be apparent to one of skill in the relevant arts of education, advertising, product or services promotion, and collection of customer information that this invention can be applied at all levels of learning and to all forms of public, commercial, or corporate education. In all these contexts, this invention has particular utility in making distributed materials available at schools, at offices, in homes, and to participants at any other location. Furthermore, it will be apparent that this invention can be applied in contexts other than education and the subsequent rewarding of demonstrated proficiency of the subject material. For instance, the materials distributed to participants could take the form or a contest and rewards be given based on appropriate responses or actions.

The system and method of this invention are also described in the context of computer-driven, client-server technology based on communication via the Internet. However, this invention is not so limited. The scheme employed in this invention could just as well—although more slowly—be accomplished through other forms of communication. It is assumed that, in the future, this invention will be used in even more technically advanced systems than those based on the Internet model described herrein.

The principal functional components of An Incentive-based Learning System to Promote Products or Services are:

1) A computer capable of playing a CD-ROM and user access to the Internet;

2) a course of instruction (or educational materials), typically embedded on a CD-ROM, which is distributed on behalf of the award sponsoring organization to a large number of potential customers, clients, or members;

3) testing instruments, typically embedded on the same CD-ROM, which are capable of measuring the user's proficiency in understanding the educational material;

4) instructions and software, typically embedded on the same CD-ROM, which enable the user to link up his or her computer to a server of the sponsoring organization;

5) computing capability at the sponsoring organization's server that can process responses to questions, can automatically change the basis for allocating rewards to responders, can manage the process of issuing rewards, can collect data on the participants, and can manage the whole program from an administrative point of view.

All of the above components could be distributed by or incorporated into other forms of communication.

In this scheme, instructional designers will endeavor to create interactive educational materials appropriate to the grade level of the target audience. This would include print, graphic design, animation, audio, and video elements designed to interactively engage the user in the learning process. As the user proceeds through the course of instruction at his or her own pace, from time to time he or she will encounter questions (or prompts to take action) that measure the user's understanding of the material presented to that point. If the user demonstrates a lack of understanding, he or she will be redirected back to the materials not yet mastered. Upon successfully answering questions, the user is instructed in how to enter (or is automatically linked up to) the sponsoring organization's service portal. Once connected, “real-time” interaction between the user and the sponsoring organization's server takes place. This client-server interaction can be designed to repeat any number of times during the course of instruction and, on each occasion, the sponsoring organization will glean information it seeks about the user and, as appropriate, award a benefit to the user.

In a computer-based application of this invention, software embedded in the distributed materials will directly guide the user in the course of learning and facilitate the communication between client and server. Communication will occur in two manners: synchronously, in which the user directly makes meta-requests to the instructional material software (or to the sponsoring organization's server) and receives meta-responses; and second, asynchronously, in which the instructional material software (or sponsoring organization's server) generates a meta-response in response to some interactive event. Such meta-responses could take the form of reminders, encouragements, reinforcements, paraphrases, jokes, progress summaries, etc. On-screen help will appear on the user's monitor in the form of the sponsoring organization's logo or spokespersons—for instance, the animated comic character Snoopy might appear on-screen to augment an instructional program sponsored by MetLife. Embedded “hot-links” are also employed in the educational materials to aid users in finding other WebPages that provide useful information on the topic being studied. For instance, a link to data on home mortgage interest rates might be found in educational materials on financial literacy.

There are many experts in the design of educational materials and many available products to assist instructional designers, including Macromedia's Authorware and Director, Asymetrix's Multimedia Toolbook, and Aimtech's IconAuthor. The variety and nature of the educational materials is almost unlimited. Some materials may incorporate a story line—others may take the form of a animated comic strip. Producing educational materials is more an art than a science.

The preferred implementation of this invention is based on widespread distribution of CD-ROMs to users who have access to computers which can be connected to the Internet. Alternatively, this invention could utilize an “intranet” network constructed according to TCP/IP protocols but using proprietary links. It is assumed that the sponsoring organization will have the technological resources to accept Internet (or intranet) traffic, to collect data on the correspondents, and to manage the process for awarding benefits to participants who meet certain criteria. These sponsoring organization capabilities include storing data objects, software for implementing the award scheme, central hosting, participant tracking, statistical analysis, access controls, system logs, and administrative analysis of results.

Without further description, the foregoing reveals the gist of the present invention so that others can, by applying current knowledge, readily adapt it for various applications without omitting features that, from the standpoint of prior art, fairly constitute essential characteristics of the generic or specific aspects of this invention. Furthermore, the present invention is not to be limited in scope by the specific embodiments described herein. Indeed, various modifications of the invention in addition to those described herein will become apparent to those skilled in the arts of educational materials, advertising, product promotion, and customer data collection. Such modifications are intended to fall within the scope of the appended claims.

What I claim as my invention is:

1. that this is a new and unique method for an organization to sponsor educational materials to a large group of individuals and, subsequently, for the sponsoring organization to immediately be able to reward any individual student/user upon demonstration of proficiency in the subject matter, said method comprising:
either 1) a CD-ROM containing embedded user instructions, embedded instructional materials, embedded testing instruments, and necessary embedded software and codes to electronically link the student/user to a server controlled by the organization (or their agent) issuing the rewards, or 2) a WebPage controlled by the reward-issuing organization (or their agent) from which a student/user can interactively download the user instructions, the instructional materials, the testing instruments, and the embedded codes to electronically link the student/user to a server controlled by the organization (or their agent) issuing the rewards, or 3) a print version of the user instructions, the instructional materials, the testing instruments, and information on how the student/user can electronically link to or correspond with the organization (or their agent) issuing the rewards;
educational content modalities consisting of text, graphics, speech, audio, animation, preformatted animated sequences and/or video presentation;
educational materials designed to require each student/user to interact responsively while engaged in the process of learning the subject matter;
the inclusion of interactive testing instruments or other required actions (in both the educational materials and on the server of the reward-issuing organization) that measure the student/user's understanding of the subject matter intended to be learned;
server resources and software at the reward-issuing organization capable of supporting communication between the student/user and the reward-issuing organization (or its agent);
server resources and software at the reward-issuing organization capable of supporting an automated system whereby the reward-issuing organization (or its agent) can randomly change the actions and/or correct answers that will lead to a reward;
server resources and software at the reward-issuing organization capable of managing the issuance of rewards;
server resources and software at the reward-issuing organization capable of supporting the ability of the reward-issuing organization (or its agent) to automatically collect and store data on each student/user;
server resources and software at the reward-issuing organization capable of supporting security protocols to check the authority of each student/user to access his or her educational account; and
server resources and software at the reward-issuing organization capable of supporting administrative analysis of the effectiveness of the rewards-for-learning campaign.
